(19) United States
(12) Patent Application Publication
(10) Pub. No.: US 2014/0272891 A1
(43) Pub. Date: Sep. 18, 2014

(54) SYSTEM AND METHOD FOR REMOTE FITNESS TRAINING

(71) Applicants: Joseph Saladino, Huntington, NY (US); Don Saladino, Cold Spring Harbor, NY (US); Anthony Connors, New York, NY (US); Andreas Huber, Garden City, NY (US)

(72) Inventors: Joseph Saladino, Huntington, NY (US); Don Saladino, Cold Spring Harbor, NY (US); Anthony Connors, New York, NY (US); Andreas Huber, Garden City, NY (US)

(21) Appl. No.: 13/840,121

(22) Filed: Mar. 15, 2013

(51) Int. Cl. G09B 5/02; G09B 5/08; G09B 5/04

(52) U.S. Cl. CPC G09B 5/02; G09B 5/04; G09B 5/08
USPC 434/350

(57) ABSTRACT

Systems, methods, and apparatus for remote education. In one aspect, the disclosed method includes the steps of recording, at an instructor device, a lesson plan, the lesson plan including at least one lesson service identifier, associating the lesson plan with at least one student, storing, in a database accessible to an application server, the lesson plan and the at least one student association of the lesson plan, receiving, at a student device associated with the lesson plan, the associated lesson plan, determining a physical location of the student device, identifying a facility service identifier associated with the physical location, comparing the lesson service identifier associated with the lesson to the facility service identifier associated with the physical location, and revising the lesson in accordance with the comparison.

### BACKGROUND

The consumer lifestyle and office-based employment has been a boon for the fitness industry. Whereas in the past, physical activity constituted a significant component of an average person's daily routine, nowadays the proliferation of knowledge-based jobs in which workers typically sit at desks, together with a sedentary lifestyle brought about by convenient and ready access to personal entertainment, has more and more people going to the gym. As a result, the fitness training industry now accounts for over $20 billion in revenue annually in the United States.

Gyms, or fitness centers as they are sometimes called, offer an array of services and equipment directed to basic fitness training that is broadly categorized into cardiovascular training, weight training, and sports training. Cardiovascular training, also referred to as aerobic exercise or endurance training, focuses on conditioning the circulatory and respiratory systems and employs jogging, running, and the use of treadmills, stair machine, and elliptical machine to increase heart rate and burn calories. Weight training, also known as anaerobic exercise, involves the use of freeweights and weight training machines such as Nautilus™ machines and focuses on strengthening the musculoskeletal system. Sports training, on the other hand, involves skills training directed to specific sports, such as golf and tennis, and may additionally incorporate elements of cardiovascular and weight training.

Frequently, a person may work one-on-one with a personal fitness trainer. Use of a dedicated fitness trainer may have benefits. The personal trainer is able to recognize strengths, weaknesses, and progress of an individual client, and in response, create a precisely-tailored workout routine that addresses the client's needs. Consistency is key to success in any endeavor, and this is particularly true with respect to physical fitness training. That is, in order to achieve solid results, an athlete must train regularly.

Physical therapy is discipline in which patients work closely with physical therapists to perform a prescribed course of exercises and movements intended to provide recuperative and therapeutic benefits to those recovering from injuries, surgeries, and maladies. As with fitness training, effective and successful physical therapy depends upon performing the prescribed therapy regimen correctly and consistently.

Unfortunately, aspects of daily life may interfere with a person's ability to fitness train or perform physical therapy regularly. In particular, many types of employment involve business travel that may take a person on the road for days or even weeks at a time, which makes regular training sessions, gym visits, and/or physical therapy sessions difficult or impossible. While many hotels and motels offer their own fitness centers, the type and selection of equipment invariably differs from that of the person's home gym, which makes it difficult or impossible for the person to perform a workout routine that requires particular exercises to be performed on particular machines. And even if the hotel gym offers the necessary equipment, most people do not have the means to travel with a personal trainer, so the benefits, customized training, and immediate feedback of working with one's trainer or therapist are lost while on the road.

### SUMMARY

Embodiments in accordance with the present disclosure enables an enterprise to target teacher/student relationships and provide a framework to teachers and students alike, so they can be connected wherever they may travel. Embodiments according to the present disclosure solve the problem associated with individuals traveling and not being able to remember their workout, or golf students going away to play on a trip and forgetting the swing drills they need to work on. Thus, instead of, for example, a student having to retrieve old emails or random clips, a student will have his or her own library of exercises presented in a structured manner. The instructor will also have access to a library of pre-recorded exercises and drills that are provided embodiments according to the present disclosure. In addition, various instructor levels may be offered, for example, a trainer (local instructor), pro (a career instructor), and celebrity (well-known professional athlete).

An instructor, for example, a trainer or therapist, from any field of fitness training, for example, golf, physical therapy, and so forth, may send routines, drills, or any video demonstration desired to the client or patient. In this manner, a person may access personalized training and physical therapy instructions at any location. The application supports any instructor/student relationship, e.g., golf pro/student, personal trainer/client, physical therapist/patient, sports coach/athlete.

According to one aspect of the present disclosure, a system for remote education is disclosed. The disclosed system includes an instructor device configured to record a lesson plan and to associate the lesson plan with at least one student. The system includes a student storing unit in operable communication with the instructor device and configured to store data representing one or more students. The system includes an application server that includes a processor in operable communication with the lesson storing unit, the student storing unit, and the geolocation unit, a memory operably associated with the processor and configured to store a set of executable instructions. When executed, the executable instructions performing a method of receiving a request from a student device, receiving a location of the student device, selecting a lesson plan in accordance with the request and location, and transmitting the selected lesson plan to the student device. The system includes a student device configured to receive the selected lesson plan and to present the lesson plan to a student.

In some embodiments, the lesson plan includes at least one of a video component, an audio component, or a text component. In some embodiments, the components of the lesson plan are temporally synchronized.

In some embodiments, the disclosed system includes a geolocation unit in operable communication with the student device and lesson storing unit and configured to store data representing one or more educational facilities. In some embodiments, the data relating to one or more educational facilities is selected from the group consisting of a physical location data of a facility, a street address, an intersection, a latitude and longitude, an intersection, and a facility service identifier. In some embodiments, the data representing one or more lesson plans includes a lesson service identifier.

In some embodiments, the disclosed system further includes a translation engine configured to translate text between a source language and a target language.

In another aspect of the present disclosure, an apparatus for remote education is disclosed. The disclosed apparatus includes a processor, a network interface in operative communication with the processor, a user interface in operative communication with the processor, and an app module. The app module includes an identification data unit configured to store identification data of a user of the apparatus, a presentation unit configured to present a lesson based at least in part upon criteria selected from the group consisting of a student identifier, a lesson schedule, and a location of the apparatus, and a communication unit configured to transmit and/or receive a lesson from an application server.

In some embodiments of the apparatus, the app module includes a lesson data unit storing one or more lessons associated with the user of the apparatus.

In some embodiments of the apparatus, the app module includes a lesson repository unit storing one or more lessons associated with a lesson provider.

In some embodiments of the apparatus, the app module includes a production unit configured to record a lesson.

In some embodiments of the apparatus, the app module includes a student data unit configured to store a student identifier in accordance with a recorded lesson.

In some embodiments of the apparatus, the production unit is configured to associate an annotation with a lesson. In some embodiments, the annotation is temporally synchronized with the lesson.

In some embodiments, the apparatus further includes a location unit configured to determine a physical location of the apparatus.

In still another aspect of the present disclosure, a method for remote education is disclosed. The disclosed method includes the steps of recording, at an instructor device, a lesson plan, the lesson plan including at least one lesson service identifier, associating the lesson plan with at least one student, storing, in a database accessible to an application server, the lesson plan and the at least one student association of the lesson plan, receiving, at a student device associated with the lesson plan, the associated lesson plan, determining a physical location of the student device, identifying a facility service identifier associated with the physical location, comparing the lesson service identifier associated with the lesson to the facility service identifier associated with the physical location, and revising the lesson in accordance with the comparison.

In some embodiments, the disclosed method includes annotating, at the instructor device, the recorded lesson plan.

In some embodiments, the disclosed method includes translating a lesson from a source language to a target language.

In some embodiments, the disclosed method includes presenting, at the student device, the lesson.

In some embodiments, the disclosed method includes recording, at the student device, a biological parameter of a student, and transmitting, to the instructor device, the recorded biological parameter.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a block diagram of an embodiment of a remote fitness training system in accordance with the present disclosure;

FIG. 2 is a block diagram of an embodiment of a student device of a remote fitness training system in accordance with the present disclosure; and

FIG. 3 is a block diagram of an embodiment of an instructor device remote fitness training system in accordance with the present disclosure.

### DETAILED DESCRIPTION

Particular embodiments of the present disclosure are described hereinbelow with reference to the accompanying drawings; however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure. In this description, as well as in the drawings, like-referenced numbers represent elements which may perform the same, similar, or equivalent functions.

Additionally, the present invention may be described herein in terms of functional block components, code listings, optional selections, page displays, and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, C#, Java, COBOL, assembler, PERL, Python, PHP, or the like, with the various algorithms being implemented with any combination of data structures, objects, processes, routines or other programming elements. The object code created may be executed on a variety of operating systems including, without limitation, Windows®, Macintosh OSX®, iOS®, Linux, and/or Android®.

Further, it should be noted that the present invention may employ any number of conventional techniques for data transmission, signaling, data processing, network control, and the like. It should be appreciated that the particular implementations shown and described herein are illustrative of the invention and its best mode and are not intended to otherwise limit the scope of the present invention in any way. Examples are presented herein which may include sample data items (e.g., names, dates, etc.) which are intended as examples and are not to be construed as limiting. Indeed, for the sake of brevity, conventional data networking, application development and other functional aspects of the systems (and components of the individual operating components of the systems) may not be described in detail herein. Furthermore, the connecting lines shown in the various figures contained herein are intended to represent example functional relationships and/or physical or virtual couplings between the various elements. It should be noted that many alternative or additional functional relationships or physical or virtual connections may be present in a practical electronic data communications system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, DVD-ROM, optical storage devices, magnetic storage devices, semiconductor storage devices (e.g., USB thumb drives) and/or the like.

In the discussion contained herein, the terms “user interface element” and/or “button” are understood to be non-limiting, and include other user interface elements such as, without limitation, a hyperlink, clickable image, and the like.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, mobile device or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

FIG. 1 illustrates a computer-implemented remote fitness training system 100 in accordance with the present disclosure which provides remote education in a teacher-student relationship. The disclosed remote fitness training system 100 includes one or more student devices 200, one or more instructor devices 300, an application server or “app” server 400, and a database 500. The disclosed remote fitness training system 100 includes a payment server 105. The one or more student devices 200, one or more instructor device 300, and payment server 105 are in operable communication with app server 400. In the present embodiment shown in FIG. 1, student devices 200, instructor device 300, and payment server 105 communicate with app server 400 via data network 115. Data network may include any combination of the public Internet, private networks (LANs, WANs, VPNs), public wireless networks (cellular, WiFi, and the like) and/or any other communication network now or in the future known.

App server 400 performs a number of functions associated with the operation of remote fitness training system 100, relating to, without limitation, user authentication, database access and data caching, payment processing, and language processing. App server 400 includes a processor 440 in operable communication with a memory 450, which may include transitory memory (RAM), non-transitory memory (ROM, hard disk, solid state (flash, SSD) memory, optical memory, and the like.

App server 400 includes a language module 410 that receives a client language preference parameter (discussed in detail below) that indicates a student or instructor's preferred language in which lessons and user interface elements are to be presented. In response to receiving a client language preference parameter, the language module 410 will mediate language-based communications among and between student device 200, instructor device 300, other modules of app server 400 (including, without limitation, authentication module 420, payment module 430, processor 440, and memory 450), and database 500. In some embodiments, language module 410 includes a translation engine configured to translate text between a source language and a target language on an as needed basis. In some embodiments, the translation engine is in operable communication with a remote translation service provider via a SOAP, RESTful, or API interface. In some embodiments, language module 410 includes one or more look-up tables which map a desired user interface element, or lesson component, into the appropriate representation in the language specified by the client language preference parameter.

App server 400 provides authentication services to a student device 200 and/or an instructor device 300 to control access to the database 500. App server 400 includes an authentication module 420. Authentication module 410 is configured to receive an access request from student device 200 and/or instructor device 300 and to determine whether the device should be granted access to the functionality of the remote fitness training system 100, e.g., whether the device should be granted access to app server 400 and/or database 500. An access request may include a username, a password, an authorization key, a coupon code, and/or any suitable indicia identifying the student device 200 and/or instructor device 300. Authentication module 420 is in operable communication with authorization table 550 of database 500. Authorization table 550 includes data relating to the users (e.g., students, instructors, system administrators, etc.) who are authorized to access remote fitness training system 100.

A student device 200 enables a student to interact with the remote fitness training system 100. Student device 200 includes, in operable communication, a location unit 250, a network interface 255, a user interface 260, a processor 270, and a student app 210. Student app 210 includes an identification unit 215, a lesson data unit 220, a communication unit 230, and a presentation unit 235. Network interface 255 may include one or more data communication ports, which may be wired and/or wireless, such as without limitation, Bluetooth®, 802.11 WiFi, and/or GSM or CDMA cellular. Student device 200 may include, in operable association, one or more bio sensors 280 that provide a biological parameter from the student during exercise. For example, heart rate, blood pressure, blood oxygen, respiration, perspiration, and so forth may be monitored and stored in student device 200 and/or transmitted to database 500 or instructor device 300 for offline or real-time analysis by the instructor. In embodiments, the one or more bio sensors 280 communicate with student device 200 via a Bluetooth® communications link.

An instructor device 300 enables a instructor 300 to interact with the remote fitness training system 100. Instructor device 300 includes, in operable communication, a a network interface 355, a user interface 360, a media capture unit 365 a processor 370, and an instructor app 310. Instructor app 310 includes an identification unit 315, a student data unit 320, a lesson repository unit 325, a communication unit 330, and a presentation unit 335, and a production unit 340.

Remote fitness training system 100 enables an individual using a student device 200 to access customized lessons, such as without limitation, video demonstrations. Student device may include a smart phone, a notebook computer, a tablet computer, and a set-top box. Student app 210 is executable on the mobile device to enable access to educational content when the student is away from the instructor. Remote fitness training system 100 includes a database 500 storing a number of tables in support of the disclosed functionality. Included within database 500 are exercise table 510 storing a set of exercises (which may include lessons, drills, etc.) Each row of exercise table 510 may be related to one or more media files 525. Each media file 525 may include a video clip, an audio clip, and/or may include one or more animation primitives (e.g., animation keyframes) which may be rendered on student device 200 and/or instructor device 300. Exercise table 510 may be related to routines table 540. A “routine” may be defined as a collection of exercises. Thus routines table 540 stores associations between one or more exercises stored in exercise table 510.

Database 500 includes client table 515 storing a one or more users of the system, or system clients, e.g., individuals or organizational entities, which utilize remote fitness training system 100. In some embodiments, a system client may be characterized as an individual subscriber of the system. Client table 515 may include a grouping code which associates groups of individuals in accordance with an organizational structure, for example and without limitation, as a separate physical location within a chain of fitness centers. In some embodiments, a system client may be grouped by franchisees within a franchise structure. In some embodiments, a system client may be characterized as patrons of one or more separate business entities which, in turn, subscribe to remote fitness training system 100. In this manner, flexibility and scalability may be achieved, and the disclosed remote fitness training system 100 may be made available to a single user, a single operator (e.g., gym owner), to a chain of gyms, to a business cooperative, multi-national corporation, and so forth.

In one envisioned usage case, an instructor (e.g., personal trainer, physical therapist, and the like) purchases an instructor app 310, and advises his or her clients (e.g., athletes, patients, and other students of the instructor) to purchase a student app 210. The student app 210 and/or instructor app 310 may be obtained from an online provider, such as without limitation, the Apple App Store® or Google Play®.

The instructor can then record one or more videos depicting a lesson, demonstration, or exercise. A “record lesson” command is input to instructor device 300 via user interface 360. In response, production unit 340 captures (e.g., digitizes) a video and/or audio lesson presented by the instructor. In embodiments, production unit 340 includes at least one of a video camera and a microphone configured to record media. The instructor may review the recorded media via presentation unit 335. In embodiments, presentation unit 335 and/or production unit 340 provides the capability to edit or selectively re-record at least a portion of the recorded media. In embodiments, presentation unit 335 and/or production unit 340 provides the capability to add annotations (e.g., textual overlays) to the recorded media. Additionally or alternatively, the instructor may specify what, if any, exercise equipment is required to perform the exercise recorded in the media clip. The equipment list is stored in association with the exercise table 510 entry associated with the recorded exercise. Once the instructor is satisfied with the recorded media, the recorded media is communicated via network 155 and/or direct connection 305 (e.g., an electrical or optical cable) to database 500 for storing as a media file 525. The instructor may enable access to the video for use by one or more intended students by associating the stored media file with one or more students. Additionally or alternatively, the media file may be scheduled to be presented to a desired student at a designated time and/or on a recurring basis. In some embodiments, the media clip may be “pushed” to the student device at the designated time(s). The student may then access the lesson material by entering authentication credentials (e.g., username, password, PIN, etc.) via user interface 260 of student device 200. The credentials are communicated to app server 400, processed by authentication module 420 by comparing the authentication credential to corresponding user data in authorization table 550, and if correct credentials are provided, access to the requested media, lesson, etc. is enabled. In embodiments, at least a part of a user's e.g., a student's or an instructor's)) credentials may be stored in identification unit 215 (for a student) or identification unit 315 (for an instructor).

In embodiments, one or more pre-produced media files may be provided for use by the student and/or instructor and which may include special “celebrity” lessons featuring a famous athlete. In embodiments, special “celebrity” lessons may be purchased on a subscription or individual basis. Such purchases, as well as other fiscal transactions, may be conducted in association with payment server 105.

The instructor device 300 is configured to enable an instructor to define one or more lesson plans that are presented on a student device 200 to a student. Student device 200 and instructor device 300 are in operable communication with database 500. Instructor device 300 may include a personal computer, a mobile device (smartphone), a tablet computer, and so forth. Database 500 includes having one or more tables, which may include relations therebetween, that includes an exercise table 510, a client table 515 and/or a student table, a geolocation table 545, and an authentication table 550. The database may optionally include a join table 530 for facilitating data relations between two or more tables within the database, a calendar table 520, a scheduling table 555, and/or a routine table 540. Student device 200 is in operable communication with the database and configured to facilitate display of and interaction with assigned lesson plans. In some embodiments, the student device may include a smartphone (e.g., an iPhone™, a Blackberry™, and/or an Android phone), a tablet device (e.g., an iOS® device an Android® tablet, a PC running any suitable OS, including Mac OSX®, Windows®, and/or linux), a set top box (e.g., a “cable box” designed to be used in connection with a television provided in, for example, a hotel room or hotel gym). The student device includes a location unit 250 configured to determine the physical location of the student device (and, by extension, the student). In embodiments location unit 250 includes, without limitation, a GPS receiver configured to receive one or more GPS signals from a constellation of GPS satellites 110 and/or a cellular triangulation module. Student device 200 may additionally or alternatively be configured to permit manual (user) input of a location, which may be based on a landmark, a zipcode, or other indicia of physical location.

Instructor device 300 includes a user interface 360 that enables an instructor to prepare lesson plans for his or her students. The user interface 360 may include any suitable user interface elements and structures adapted to facilitate the input, modification, review, arrangement, etc. of lesson plan elements. For example, and without limitation, user interface device may include a keyboard, a pointing device (mouse, trackpad, stylus, etc.), and/or a touchscreen. Instructor device 300 includes media capture unit 365 that includes a video camera, a still camera, and/or a microphone. In some embodiments, a lesson plan may be created using a web browser running on any suitable hardware. An instructor may use a smartphone for recording videos and entering exercise routines into database 500. An instructor device may be hardwired to the database, and/or may access the database wirelessly through local WiFi, or over a cellular network through a trainer portal provided by the app server 400. In some embodiments, the instructor device includes the capability to enable the instructor to add annotations to the routine, such as, without limitation, telestration, titles, crawls, graphics, video superimposition, and so forth. Text annotations may be presented in synchronization with the audio and/or video stream to facilitate student comprehension and to promote multi-sensory learning. In some embodiments text and/or audio may be recorded in alternative languages, which may be processed by language translation module 410 for translating a lesson (text, audio, etc.) from a source language to a target language. One or more audio, video, and/or text elements may be utilized in synchronization to enable the presentation of to present alternative viewing angles (front view, side view, oblique view) or alternative target audiences (male/female, younger/older, etc.), alternative audio tracks (e.g., different narration tailored to differing demographic, gender, or cultural target audiences) and the like. An input device in accordance with the present disclosure may include at least one of a video input device (video camera), a microphone, a touchscreen, a keyboard, and/or a pointing device. In embodiments, an input device may include a tablet computer, a smart phone, and/or a personal computer.

Database 500 includes a geolocation tables 545 that is configured to store data relating to equipment and personnel that may be available at one or more remotes sites, e.g., at hotel gyms, affiliate gyms, universities, clinics, and any other suitable venue that may be available to a traveling student. Geolocation table 545 may include a physical location data of a facility or premises (e.g., gym, therapist office, etc.). The physical location may include a street address, an intersection, a latitude and longitude, an intersection. Geolocation table 545 stores, in association with a physical location (facility) one or more service identifiers. A service identifier may represent a particular service, equipment, or amenity that is available at the facility. A service identifier may represent whether a particular piece of exercise equipment is available for use at the facility. The service identifier may include the make, model, type, and quantity of each machine, freeweight, and accessory in the facility. For example, a service identifier may include information such as “dumbbell/25 lbs/qty:4” or “treadmill/Lifecycle Elevation Series 95T Engage Treadmill/qty:6” and so forth. As will be familiar to one skilled in the art, database data may be stored using any suitable form of encoding, including ASCII, binary encoded, and so forth.

A service identifier may include data relating to personnel available at a facility, such as without limitation, “golf pro/Arnold Palmieri/qty:1/rate:$100”. In this manner, a student visiting a particular gym need only consult student app 200, which communicates the student's geolocation data to geolocation table 545, which, in turn, initiates a comparison between the equipment required to perform the scheduled exercise (stored in association with exercise table 510) and the equipment available at the remote site (stored in association with geolocation table 545). This enables student app 200 to determine the suitability of a particular facility with respect to the student's lesson plan. In some embodiments, geolocation table 545 may be associated with a facility's website for booking purposes. In some embodiments, the disclosed system includes a communications link coupling the geolocation table 545 with other (remote) facilities to provide dynamic updating to the geolocation database by the remote facilities. By this communications link, the geolocation database may maintain an accurate and current representation of the state of a remote facility, which, in turn, enables a student to plan and adapt exercise regimens and the like in view thereof.

In another aspect, the disclosed remote fitness training system 100 includes a student table 515 that is configured to store personal information about students. The student table 515 may include, without limitation, student name, address, biometric information (age, weight, height, gender, body mass index, left- or right-handed, medical conditions), a training goal, a home facility, a membership identifier, and a privilege identifier.

The disclosed remote fitness training system 100 includes an exercise table 510 configured to store individual exercises or lessons. The exercise table 510 may include, without limitation, an exercise identifier, an exercise name, an access identifier (e.g., public exercise, private exercise, customer exercise, etc.), a text description of the exercise or lesson, and may store in association therewith one or more a media files 525, such as a video clip that may demonstrate the exercise, and an audio clip that may contain verbal instructions, music, or other audio information. The disclosed remote fitness training system 100 may optionally provide “pre-loaded” exercises which may include one or more standardized exercises. An instructor may optionally add additional exercises to the database using instructor device 300. An exercise may be designated as a public exercise (e.g., with reduced or no authentication criteria provided in connection therewith), thereby making the exercise accessible by all users of the system. Alternatively, an exercise may be designated as a private exercise accessible to one user or a specified group of users. Other exercise classifications are envisioned, such as without limitation, a custom exercise, a time-limited exercise, and so forth. By controlling access to exercises, an instructor may, for example, restrict students to accessing only appropriate exercises, and/or discourage competing instructors/trainers from copying proprietary exercises.

One or more schedule tables 55 may be included in the disclosed system that associates a student with a group of exercises to define a workout schedule. In some embodiments a schedule table 555 may include a join table 530 that relates students, instructors, exercises, and scheduling data. An instructor may utilize instructor device 300 to create a schedule for each student by inputting one or more of a desired exercise, a number of sets, a number of repetitions per set, a target exercise time, a target heart rate, a time of day, a day of week, and a repetition identifier (e.g., repeat every other day, repeat on alternating cycle, repeat twice after performing another predefined exercise, etc.). One or more predefined exercise schedules (e.g., templates) may be stored in schedule table 555. The predefined templates may enable an instructor to save time by storing one or more “standard” schedules, retrieving a stored schedule template, and storing a copy of the template in association with a student. Optionally, the schedule template may be modified or customized by the instructor in accordance with the needs of a specific student.

In embodiments, app server 400 is configured to provide instructors and/or students access to lessons via the public Internet. In one aspect, app server 400 receives a connection request from a student device 200 or an instructor device 300. Authentication unit 420 is configured to grant appropriate access to students and/or instructors. When a connection request is received, identification information included within the connection request is compared to authentication data stored within the authentication unit 410. An authentication token, e.g., a password, may be solicited from the user of the requesting device to confirm the identity of the user. In some embodiments, an authentication token may be stored within the requesting device e.g., in identification unit 215 or identification unit 315, and provided automatically by the requesting device to the application server. In this manner, the type (e.g., student or instructor) and identity of the user may be determined, which, in turn, enables the system to provide appropriate services to the user.

For example, a student may wish to view the exercise plan for the day. Using a student device, the user initiates access to app server 400 via student app 210, or, alternatively, a web browser application (e.g., a java applet). App server 400 receives the access request and, determines whether the student should be granted access to the system. Once the student has been authenticated, app server 400 retrieves lesson data associated with the student from database 500. The lesson data may be selected in accordance with additional criteria, including without limitation, an exercise schedule, a date, a day of week, a time of day, biometric data, location data, and the like. In this manner the exercises (lessons) presented to the user may be tailored in accordance with the instructor's lesson plan.

In one non-limiting example, an instructor may create a lesson plan for the student whereby weight training is performed on Tuesdays and Fridays, cardiovascular training is performed on Mondays, Wednesdays, and Saturdays, with Thursdays and Sundays off. App server 400, upon receiving a student device access request from student device 200, authenticates the user, identifies the current day-of-week, and transmits the appropriate exercise data and, if available, related media (video and/or audio) to the student device. The exercise data and/or the related media may be cached in lesson data unit 220. Continuing with the present example, assume the instructor has specified that the weight training includes use of a shoulder press machine, a chest press machine, and a leg press machine, and that the current-of-week is a Friday (i.e., a weight training day). Location unit 250, in association with geolocation table 545, indicates the user is at a gym facility that has a leg press machine, but no chest press machine nor a shoulder press machine. In response, the app server 400 may query the geolocation database to determine whether equipment is available at the current gym facility that would provide an equivalent, or near-equivalent, exercise benefit as would the instructor-specified machine.

Continuing with the present example, assume the current gym offers a Smith machine, a weight bench, barbells, and dumbbells. An equivalence unit 460 of app server 400 determines that, as a substitute for a chest press machine, a Smith machine is preferable to a using barbells with a weight bench (since the Smith machine employs a safety catch that prevents the bar from “guillotining” the student reaches muscle failure during a repetition). App server 400 therefore substitutes the Smith machine for the chest machine (e.g., the equivalence equipment). App server 400 may optionally modify the weight setting, repetitions, and/or sets to compensate for different muscles targeted by the substitute exercise (e.g., the Smith machine exercise) as contrasted to the instructor's planned exercise.

In some embodiments, the instructor may designate one or more alternate exercises and machines (e.g., first choice, second choice, third choice, etc) in accordance with his or her training methodologies. Continuing still with the present example, an instructor may prefer dumbbell shoulder presses to Smith machine shoulder presses. In this instance, app server 400 will substitute a dumbbell shoulder routine in place of the shoulder press machine exercise.

In some embodiments, the disclosed system includes an equivalence unit 460. Additionally or alternatively, the student device may be in operable communication with a local equipment database provided by the current gym via, e.g., a wireless communication link. In this embodiment, the equivalence unit obtains a list of available equipment from the local equipment database to determine the equivalence equipment. The local equipment database may be included within an application program executing on a computer provided by the current gym and configured for wireless communication in the vicinity of the current gym via., e.g., a local WiFi network.

In some embodiments, a student may utilize a camera, such as a camera included within a smartphone, to record a barcode, logo, model number, serial number, etc., associated with exercise equipment available at the current gym. The images may be processed to extract the visually-encoded data, and the extracted data may be stored in database 500 for immediate or future reference. In this manner, the local equipment database may be populated on the fly, by users, which becomes part of the overall knowledgebase of the system. In addition, the current location of the user is stored, so that equivalence processing is available to future visitors of the current gym. In yet other embodiments, user comments and reviews may be stored in association with information relating to the current gym.

In some embodiments, a system and method in accordance with the present disclosure may include one or more bundled libraries of lessons stored in bundle table 525. The lessons may include, without limitation, a demonstration of how to perform any particular activity, e.g., fitness exercises, sports drills, rehabilitation therapy movements, yoga, martial arts, and/or any other activity (cooking, baking, public speaking, mathematics, musical exercises, etc.) In some embodiments, the lessons are bundled according to the instructor or author of the lessons, which may be a celebrity instructor, sports professional, and the like. An application in accordance with some embodiments of the present disclosure many include a bundle purchase module that enables a user to search for, purchase, and/or download a lesson or lesson bundle for use within the application. For example, and without limitation, a user may employ the bundle purchase module to access a library of workout lessons by a famous fitness expert, a library of golf lessons from a famous golf pro, a library of cooking recipe lessons form a famous chef, and so forth. Payment server 105 conducts a transaction between the student/user and the instructor/school on a predetermined basis, e.g., a one-time library access fee, a per-use fee, a subscription (time-limited) fee, a metered-use fee (by viewing time, number of view, etc), and the like.

What is claimed is:

1. A system for remote education, comprising:
an instructor device configured to record a lesson plan and to associate the lesson plan with at least one student;
a student storing unit in operable communication with the instructor device and configured to store data representing one or more students;
an application server, comprising:
a processor in operable communication with the lesson storing unit, and the student storing unit;
a memory operably associated with the processor and configured to store a set of executable instructions for performing a method of:
receiving a request from a student device;
receiving a location of the student device;
selecting a lesson plan in accordance with the request and location; and
transmitting the selected lesson plan to the student device; and
a student device configured to receive the selected lesson plan and to present the lesson plan to a student.

2. The system for remote education in accordance with claim 1, wherein the lesson plan includes at least one of a video component, an audio component, or a text component.

3. The system for remote education in accordance with claim 3, wherein the components of the lesson plan are temporally synchronized.

4. The system for remote education in accordance with claim 1, further comprising a geolocation unit in operable communication with the student device and lesson storing unit and configured to store data representing one or more educational facilities.

5. The system for remote education in accordance with claim 4, wherein data relating to one or more educational facilities is selected from the group consisting of a physical location data of a facility, a street address, an intersection, a latitude and longitude, an intersection, and a facility service identifier.

6. The system for remote education in accordance with claim 1, wherein the application server further comprises a translation engine configured to translate text between a source language and a target language.

7. The system for remote education in accordance with claim 1, wherein the data representing one or more lesson plans includes a lesson service identifier.

8. An apparatus for remote education, comprising:
a processor;
a network interface in operative communication with the processor;
a user interface in operative communication with the processor; and
an app module, comprising:
an identification data unit configured to store identification data of a user of the apparatus;
a presentation unit configured to present a lesson based at least in part upon criteria selected from the group consisting of a student identifier, a lesson schedule, and a location of the apparatus; and
a communication unit configured to transmit and/or receive a lesson from an application server.

9. The apparatus for remote education in accordance with claim 8, wherein the app module further comprises a lesson data unit storing one or more lessons associated with the user of the apparatus.

10. The apparatus for remote education in accordance with claim 8, wherein the app module further comprises a lesson repository unit storing one or more lessons associated with a lesson provider.

11. The apparatus for remote education in accordance with claim 8, wherein the app module further comprises a production unit configured to record a lesson.

12. The apparatus for remote education in accordance with claim 11, wherein the app module further comprises a student data unit configured to store a student identifier in accordance with a recorded lesson.

13. The apparatus for remote education in accordance with claim 11, wherein the production unit further configured to associate an annotation with a lesson.

14. The apparatus for remote education in accordance with claim 13, wherein the annotation is temporally synchronized with the lesson.

15. The apparatus for remote education in accordance with claim 8, further comprising a location unit configured to determine a physical location of the apparatus.

16. A method for remote education, comprising:
recording, at an instructor device, a lesson plan, the lesson plan including at least one lesson service identifier;
associating the lesson plan with at least one student;
storing, in a database accessible to an application server, the lesson plan and the at least one student association of the lesson plan;
receiving, at a student device associated with the lesson plan, the associated lesson plan;
determining a physical location of the student device;
identifying a facility service identifier associated with the physical location;
comparing the lesson service identifier associated with the lesson to the facility service identifier associated with the physical location; and
revising the lesson in accordance with the comparison.

17. The method in accordance with claim 16, further comprising annotating, at the instructor device, the recorded lesson plan.

18. The method in accordance with claim 16, further comprising translating a lesson from a source language to a target language.

19. The method in accordance with claim 16, further comprising presenting, at the student device, the lesson.

20. The method in accordance with claim 16, further comprising:
recording, at the student device, a biological parameter of a student; and
transmitting, to the instructor device, the recorded biological parameter.
